(19) United States
(12) Patent Application Publication
(10) Pub. No.: US 2014/0302313 A1
(43) Pub. Date: Oct. 9, 2014

(54) RADIATION CURABLE PRESSURE SENSITIVE ADHESIVE SHEET

(71) Applicant: 3M INNOVATIVE PROPERTIES COMPANY, St. Paul, MN (US)

(72) Inventors: Toshihiro Suwa, Tokyo (JP); Yasuhiro Kinoshita, Sagamihara (JP)

(73) Assignee: 3M INNOVATIVE PROPERTIES COMPANY, St. Paul, MN (US)

(21) Appl. No.: 14/238,208

(22) PCT Filed: Aug. 9, 2012
(86) PCT No.: PCT/US2012/050154

§ 371 Date: May 30, 2014

(30) Foreign Application Priority Data
Aug. 12, 2011 (JP) 2011-176853

(51) Int. Cl. C09J 133/08; C09J 7/02

(52) U.S. Cl. CPC C09J 133/08; C09J 7/0217
USPC 428/355 AC; 428/523; 525/289; 156/275.5

(57) ABSTRACT

To provide a radiation curable pressure sensitive adhesive sheet capable of yielding both a pressure sensitive adhesive sheet with good initial adhesion to an adherend before irradiation and a pressure sensitive adhesive sheet with good rigidity after irradiation. A radiation curable pressure sensitive adhesive sheet includes a (meth)acrylic copolymer having a radiation reactive site and a plasticizer capable of bonding with the (meth)acrylic copolymer upon being irradiated.

### FIELD OF THE INVENTION

The present invention relates to a radiation curable pressure sensitive adhesive sheet, as well as a laminate and a method of manufacturing the same.

### BACKGROUND

Image display modules of electronic devices such as portable phone terminals, computer displays, and the like as well as optical members such as touch panels, often have glass or a plastic film laminated thereupon as a surface protecting layer. Such surface protecting layers are affixed to the image display module or touch panel via the application of a frame-shaped tape or an adhesive to an outer blank area of the image display part or outside of the effective operating area of the touch panel. As a result, a space is formed between the image display part or effective operating area of the touch panel and the surface protecting layer.

In recent years, a method of improving the transparency and increasing the clarity of an image has become widely used, in which the space between the surface protecting layer and the image display module or touch panel is replaced by a transparent material such that the difference in refractive index between the display surface of the surface protecting layer, touch panel, and image display module is lower than that of air (in other words, a transparent material with a refractive index close to that of glass or plastic). Examples of such transparent materials include pressure sensitive adhesives, adhesives, silicone gels, and the like. If an adhesive is used, it can be difficult to apply the adhesive only to a specific area, and expensive equipment may be needed for application. In addition, stress generated from shrinkage during the curing reaction will cause the peeling or adherend warping that. Silicone gels present problems of long-term reliability due to low adhesiveness. In contrast to this, a pressure sensitive adhesive (for example, a pressure-sensitive adhesive (PSA) sheet) can be processed before hand to a predetermined shape and then applied, and also has sufficient adhesive strength and can be reapplied, making such a material effective for applying a surface protecting layer on an image display module or touch panel.

The surface of an adherend such as an image display module, optical member, or surface protecting layer may not be flat. The surface of the surface protecting layer, especially a surface coming in contact with a pressure sensitive adhesive sheet, may be printed upon for decorative or light-blocking purposes. In a number of examples, a three-dimensional surface topography, such as a 10 μm-high raised section, may be formed on a surface of the surface protecting layer by the printed portion. When a pressure sensitive adhesive sheet is used to apply a surface protecting layer on an image display module or touch panel, there is the problem, for example, that insufficient conformity to the three-dimension topography of the pressure sensitive adhesive sheet can lead to spaces being formed upon or in the vicinity of the three-dimensional surface topography. Moreover, warping from the stress caused by deformation of the pressure sensitive adhesive can cause color patches in adherends that are distortion sensitive, such as LCDs. In order to avoid these problems, it is normally necessary to impart the pressure sensitive adhesive sheet with a thickness approximately ten times the height of the three-dimensional surface topography. If a pressure sensitive adhesive with poor stress alleviation properties is used, the quality demanded when applied may not be met even if the thickness of the material is ten times or more the height of the three-dimensional surface topography.

Japanese Unexamined Patent Application Publication No. 2010-163591 describes a transparent pressure sensitive adhesive sheet for attaching a surface protecting layer or a touch panel to a display surface of an image display unit, or for attaching a surface protecting layer to a touch panel, in an image display device, wherein the transparent pressure sensitive adhesive sheet contains a monomer copolymer containing a specific (meth)acrylic alkyl ester, a specific polar monomer, and a specific (meth)acrylic ester or specific hydrophilic monomer.

The inventors have previously invented a UV crosslinkable pressure sensitive adhesive sheet containing an acrylic copolymer having a UV crosslinkable site. This pressure sensitive adhesive sheet has the advantage of demonstrating good conformity to a three-dimensional surface topography such as a raised section or bumps, even if the thickness of the sheet is roughly equal to the height of the three-dimensional surface topography (for example, from 20 to 30 μm), by applying heat and/or pressure before the UV crosslinking stage. Moreover, this advantage contributes to, for example, superior adhesive suitability for use with an image display module or optical member (namely, a reduction in spaces and other deficiencies around parts such as raised sections or bumps), and contributes to prevention of color warping during application under reduced internal stress (namely, under conditions such that excessive stress is not placed upon the adherend or pressure sensitive adhesive sheet), and the like.

By the way, in order to obtain sufficient strength, typically in order to enable sufficient resistance against pressing by a stylus or finger, a powerful pressure sensitive adhesive is demanded for some applications, and typically these will be applications with an image display module or optical member having a thin (for example, approximately from 100 to 300 μm) surface protecting layer formed from a plastic resin such as polyester, polycarbonate, or the like. According to the above invention, a pressure sensitive adhesive sheet of considerable hardness after crosslinking can be formed through irradiation with UV light, a type of radiation.

However, there is a demand for a pressure sensitive adhesive sheet enabling further improvement of the initial adhesion of the pressure sensitive adhesive sheet to the adherend, as well as further increases in the hardness of the cured pressure sensitive adhesive sheet.

An object of the present invention is to provide a radiation curable pressure sensitive adhesive sheet yielding hot melt properties accompanied by good fluidity before irradiation and good initial adhesion to an adherend, as well as good hardness after irradiation.

### SUMMARY

In one embodiment of the present disclosure, a radiation curable pressure sensitive adhesive sheet is provided, containing a (meth)acrylic copolymer having a radiation reactive site and a plasticizer capable of bonding with the (meth)acrylic copolymer upon being irradiated.

According to the present invention, a radiation curable pressure sensitive adhesive sheet is provided that yields hot melt properties accompanied by good fluidity before irradiation and good initial adhesion to an adherend, as well as good hardness after irradiation.

### BRIEF DESCRIPTION OF DRAWINGS

FIG. 1 is a cross-sectional view of one embodiment of an image display device in the form of a laminate including a radiation curable pressure sensitive adhesive sheet according to the present disclosure.

FIG. 2 is a cross-sectional view of one embodiment of a touch panel unit in the form of a laminate including a radiation curable pressure sensitive adhesive sheet according to the present disclosure.

### DETAILED DESCRIPTION

A representative embodiment of the present invention is described below in further detail for exemplary purposes, but the present invention is not restricted to this embodiment. The description within the present disclosure should not be construed as a complete disclosure of all embodiments of the present invention or of all advantages related to the present invention.

As used in the present disclosure, the term “radiation reactive site” refers to a site that is activated by irradiation and that is capable of reacting with another site. The term “radiation” comprehends ionizing radiation and non-ionizing radiation. The term “UV crosslinkable site” refers to a site that is activated by UV irradiation and that is capable of crosslinking with another site.

The term “(meth)acrylic” refers to “acrylic” or “methacrylic”, and the term “(meth)acrylate” refers to “acrylate” or “methacrylate”. The term “polyfunctional (meth)acrylate” refers to an acrylate or methacrylate, the molecule of which has two or more functional groups.

The term “plasticizer” refers to a substance having the effect of improving at least one of the flexibility and the fluidity of a target compared to when this substance has not been added to the target. One index of improved flexibility is a decrease in storage modulus, and one index of improved fluidity is an increase in melt flow rate.

The term “storage modulus” refers to storage modulus at a specific temperature when viscoelastic properties are measured in shear mode at 1 Hz and at a temperature increase rate of 5° C./minute across a temperature range from −40° C. to 200° C.

The term “hydrophilic monomer” refers to a monomer having good affinity with water; specifically, a monomer for which at least 5 g thereof will dissolve in 100 g water at 20° C.

In an embodiment of the present disclosure, a radiation curable pressure sensitive adhesive sheet (also referred to hereafter as a “pressure sensitive adhesive sheet”) is provided, which contains a (meth)acrylic copolymer having a radiation reactive site and a plasticizer capable of bonding with the (meth)acrylic copolymer upon being irradiated.

The radiation curable pressure sensitive adhesive sheet according to an embodiment of the present disclosure has hot melt properties accompanied by good fluidity and initial adhesion to an adherend before irradiation, and also has a high hardness (in particular, a high storage modulus) after irradiation (this is required in order to obtain, for example, superior resistance against pressing by a stylus).

Types of radiation that can be used to cure the radiation curable pressure sensitive adhesive sheet include UV light, visible light, electron beams, and the like. In a typical embodiment, the radiation curable pressure sensitive adhesive sheet is a pressure sensitive adhesive sheet (hereafter also referred to as a “UV crosslinkable pressure sensitive adhesive sheet”) that undergoes crosslinkage upon undergoing UV irradiation. As defined above, the radiation reactive site is a site that is activated by irradiation and capable of reacting with another site. The other sites belong to a (meth)acrylic copolymer and a plasticizer having a radiation reactive site.

The radiation curable pressure sensitive adhesive sheet according to the present disclosure is easier to handle than, for example, a liquid adhesive. Moreover, because the radiation curable pressure sensitive adhesive sheet according to the present disclosure is designed to increase in adhesive strength upon being irradiated, temporary joints and repositioning can easily be performed at a desired stage before irradiation when the sheet is used for a desired application. Therefore, the sheet can be advantageously used for applications in which a surface protecting layer is applied on a large adherend (for example, a large liquid crystal module).

The radiation curable pressure sensitive adhesive sheet according to the present disclosure has good fluidity before being irradiated. Thus, after the pressure sensitive adhesive sheet is applied to an adherend at a normal working temperature, the pressure sensitive adhesive sheet can be made to conform to a raised section, protrusion, or other three-dimensional surface topography on the surface of the adherend (for example, a surface protecting layer) by heating and/or pressurizing. The cohesion ability of the pressure sensitive adhesive sheet is subsequently increased via irradiation, resulting in highly reliable adhesion and high strength (in particular, high resistance against pressing by a stylus) because of the high hardness (in particular, the high storage modulus) of the cured pressure sensitive adhesive sheet.

The various components contained in the radiation curable pressure sensitive adhesive sheet are further described below.

### (Meth)Acrylic Copolymer Having a Radiation Reactive Site

The radiation curable pressure sensitive adhesive sheet according to an embodiment of the present disclosure contains a (meth)acrylic copolymer having a radiation reactive site (also referred to simply as a (meth)acrylic copolymer). In the (meth)acrylic copolymer, a radiation reactive site and another site that will react with the site may be present in the same or in different molecules.

The radiation reactive site is typically a photo-crosslinkable site, and more typically a UV crosslinkable site. The radiation reactive site is typically present in a side chain of the (meth)acrylic copolymer.

The (meth)acrylic copolymer having a radiation reactive site is a polymerized product of monomer components containing two or more types of monomer. In a typical example of a copolymer, at least one of the two or more types of monomer is a (meth)acryl monomer having a radiation reactive site, and the copolymer is a (meth)acrylic copolymer to which a monomer having a radiation reactive site has been added.

The amount of (meth)acryl monomer having a radiation reactive site, for example, a (meth)acrylic ester having a radiation reactive site, is generally approximately 0.1 mass %, approximately 0.2 mass %, or approximately 0.3 mass % of the total monomer component mass. An amount of (meth)acryl monomer having a radiation reactive site that is approximately 0.1 mass % or more of the total monomer component mass increases the adhesive strength of the cured pressure sensitive adhesive sheet formed via irradiation with respect to the adherend, enabling highly reliable adhesion to be obtained. The effect of increased hardness of the cured pressure sensitive adhesive sheet becomes more pronounced the greater the amount of (meth)acryl monomer having a radiation reactive site, with respect to the total monomer component mass.

A variety of structures can be employed as structures acting as radiation reactive sites. In a preferred embodiment, the radiation reactive site has an ethylenically-unsaturated structure. The ethylenically-unsaturated structure is typically present in a side chain of a (meth)acrylic copolymer. A (meth)acrylic copolymer having an ethylenically-unsaturated structure is advantageous in that it is easily crosslinkable using UV irradiation. An embodiment in which the (meth)acrylic copolymer having an ethylenically-unsaturated structure is used along with a photoinitiator capable of being excited by visible light and UV light is advantageous in that the (meth)acrylic copolymer can be crosslinked not only by UV irradiation, but also by visible light irradiation.

The ethylenically-unsaturated structure can be a structure containing a (meth)acryloyl group, a structure containing a vinyl group, or the like. A structure containing a (meth)acryloyl group is useful from considerations of reactivity and copolymerizability.

The (meth)acrylic copolymer having an ethylenically-unsaturated structure, for example, a (meth)acrylic copolymer having a (meth)acryloyl group in a side chain thereof, typically can be obtained by reacting a (meth)acrylic copolymer having a reactive group in a side chain thereof with a reactive (meth)acrylate. The (meth)acrylic copolymer having a (meth)acryloyl group in a side chain thereof is typically obtained through a two-stage reaction. In the first stage, a (meth)acrylic polymer having a reactive group in a side chain thereof is synthesized. In the second stage, the synthesized polymer is reacted with a reactive (meth)acrylate.

Various combinations of (meth)acrylic polymer having a reactive group in a side chain thereof and reactive (meth)acrylate are possible. An example of one such combination is a (meth)acrylic polymer having a hydroxyl group as a reactive group in a side chain thereof and a (meth)acrylate having an isocyanate group as a reactive group.

While not limited thereto, an example of a (meth)acrylic polymer having a hydroxyl group in a side chain thereof is a (meth)acrylate monomer copolymer including at least one monomer selected from the group consisting of 2-hydroxyethyl acrylate, 2-hydroxyethyl methacrylate, 2-hydroxypropyl acrylate, 2-hydroxypropyl methacrylate, 2-hydroxybutyl acrylate, 2-hydroxybutyl methacrylate, and 4-hydroxybutyl acrylate.

A non-exhaustive list of specific examples of (meth)acrylates having an isocyanate group includes, but is not limited to 2-acryloyloxyethyl isocyanate, 2-methacryloyloxyethyl isocyanate, and 1,1-bis(acryoloyloxymethyl)ethyl isocyanate.

A preferred example of a case in which the radiation reactive site is a UV crosslinkable site will be given. A structure capable, for example, of being excited by UV irradiation and abstracting a hydrogen radical from within the same molecule or from a different (meth)acrylic copolymer molecule, as well as from a plasticizer molecule, can be adopted for the UV crosslinkable site. Examples of such a structure include a benzophenone structure, a benzyl structure, an o-benzoyl benzoic ester structure, a thioxantone structure, a 3-ketocoumarin structure, a 2-ethylanthoraquinone structure, a camphorquinone structure, or the like. All of the above structures are capable of being excited by UV irradiation, and of abstracting a hydrogen radical from a (meth)acrylic copolymer molecule and from a plasticizer molecule when in the excited state thereof. Radicals are thus generated in the (meth)acrylic copolymer and the plasticizer, and various reactions take place within the system, such as the formation of crosslinked structures from generated radicals bonding together, the generation of peroxide radicals from reaction with oxygen molecules and the formation of crosslinked structures via the formed peroxide radicals, the drawing out of other hydrogen radicals by the generated radicals, and so on. Finally, the (meth)acrylic copolymer forms cross-linked structures between the (meth)acrylic copolymer and the plasticizer.

In another preferred embodiment, the radiation reactive site has a benzophenone structure. This embodiment is advantageous in terms of transparency and reactivity. A (meth)acrylic copolymer having a benzophenone structure is also advantageous in that it can be cured by UV irradiation alone. Examples of monomers that can be used to obtain a (meth)acrylic copolymer having a benzophenone structure include (meth)acrylic esters having a benzophenone structure, with specific examples including 4-acryloyloxy benzophenone, 4-acryloyloxyethoxy benzophenone, 4-acryloyloxy-4′-methoxy benzophenone, 4-acryloyloxyethoxy-4′-methoxy benzophenone, 4-acryloyloxy-4′-bromo benzophenone, 4-acryloyloxyethoxy-4′-bromo benzophenone, 4-methacryloyloxy benzophenone, 4-methacryloyloxyethoxy benzophenone, 4-methacryloyloxy-4′-methoxy benzophenone, 4-methacryloyloxyethoxy-4′-methoxy benzophenone, 4-methacryloyloxy-4′-bromo benzophenone, 4-methacryloyloxyethoxy-4′-bromo benzophenone, and mixtures thereof.

The monomer component can contain a (meth)acrylate alkyl ester in addition to the monomer having a radiation reactive site described above. In a preferred embodiment, the monomer component includes a (meth)acrylate alkyl ester having from 2 to 26 carbon atoms in the alkyl group, from considerations of favorable wetting properties with respect to the adherend and imparting the pressure sensitive adhesive sheet with favorable viscoelasticity. Examples of this type of (meth)acrylate alkyl ester include (meth)acrylates of non-tertiary alkyl alcohols wherein the alkyl group has 2 to 26 carbon atoms, mixtures thereof, and the like. A non-exhaustive list of specific preferred examples includes, but is not limited to, ethyl acrylate, ethyl methacrylate, n-butyl acrylate, n-butyl methacrylate, isobutyl acrylate, isobutyl methacrylate, hexyl acrylate, hexyl methacrylate, n-octyl acrylate, n-octyl methacrylate, 2-ethylhexyl acrylate, 2-ethylhexyl methacrylate, isoamyl acrylate, isooctyl acrylate, isononyl acrylate, decyl acrylate, isodecyl acrylate, isodecyl methacrylate, lauryl acrylate, lauryl methacrylate, tridecyl acrylate, tridecyl methacrylate, tetradecyl acrylate, tetradecyl methacrylate, hexadecyl acrylate, hexadecyl methacrylate, stearyl acrylate, stearyl methacrylate, isostearyl acrylate, isostearyl methacrylate, eicosanyl acrylate, eicosanyl methacrylate, hexacosanyl acrylate, hexacosanyl methacrylate, 2-methylbutyl acrylate, 4-methyl-2-pentyl acrylate, 4-t-butylcyclohexyl methacrylate, cyclohexyl methacrylate, isobornyl acrylate, mixtures thereof, and the like.

The amount of (meth)acrylate alkyl ester having from 2 to 26 carbon atoms in the alkyl group is generally approximately 60 mass % or higher, approximately 70 mass % or higher, or approximately 80 mass % or higher, and approximately 95 mass % or less, approximately 92 mass % or less, or approximately 90 mass % or less, with respect to the total monomer component mass. If the amount of (meth)acrylate alkyl ester having from 2 to 26 carbon atoms in the alkyl group is approximately 95 mass % or less with respect to the total monomer component mass, the adhesive force of the pressure sensitive adhesive sheet can be favorably ensured, and if the amount is approximately 60 mass % or higher, the elasticity of the pressure sensitive adhesive sheet will be in a suitable range, and the wettability of the pressure sensitive adhesive sheet with regard to the adherend will be favorable.

The monomer component may include other monomers in addition to the aforementioned monomers to the extent that the properties of the pressure sensitive adhesive sheet are not lost. Examples include (meth)acrylic monomers other than the aforementioned, as well as vinyl monomers such as vinyl acetate, vinyl propionate, styrene, and the like.

A hydrophilic monomer may be included among the monomer components. By using a hydrophilic monomer, it is possible to improve the adhesive strength of the pressure sensitive adhesive sheet and/or impart the pressure sensitive adhesive sheet with hydrophilic properties. If a pressure sensitive adhesive sheet imparted with hydrophilic properties is used, for example, on an image display device, clouding due to water vapor condensation can be controlled because of the ability of the pressure sensitive adhesive sheet to absorb water vapor within the image display device. This is especially advantageous when the surface protecting layer is of a material having low vapor permeability and/or when the image display device to which the pressure sensitive adhesive sheet is applied is used in a high-temperature, high-humidity environment.

Examples of such hydrophilic monomers include ethylenically-unsaturated monomers having acidic groups such as carboxylic acid, sulfonic acid, and the like, vinyl amide, N-vinyllactam, (meth)acrylamide, and mixtures thereof. A non-exhaustive list of specific examples includes acrylic acid, methacrylic acid, itaconic acid, maleic acid, styrenesulfonic acid, N-vinylpyrrolidone, N-vinylcaprolactam, N,N-dimethyl(meth)acrylamide, N,N-diethyl(meth)acrylamide, (meth)acrylonitrile, and mixtures thereof.

From considerations of adjusting the elastic modulus of the (meth)acrylic copolymer to ensure wetting properties with respect to the adherend, a (meth)acrylate hydroxyalkyl ester with 4 or less carbon atoms in the alkyl group; a (meth)acrylate containing an oxyethylene group, an oxypropylene group, an oxybutylene group, or a group having a plurality of these linked together; a (meth)acrylate having a carbonyl group in an alcohol residue, a mixture of these, or the like can be used as the hydrophilic monomer.

A hydrophilic monomer having a basic group, such as an amino group, can also be used. A (meth)acrylic copolymer obtained from a monomer containing a hydrophilic monomer having a basic group can be blended with a (meth)acrylic copolymer obtained from a monomer containing a hydrophilic monomer having an acid group, allowing coating thickness to be increased by increasing the viscosity of the coating solution, adhesive strength to be controlled, and so forth. A non-exhaustive list of specific examples includes, but is not limited to, N,N-dimethyl aminoethyl acrylate, N,N-dimethyl aminoethyl methacrylate (DMAEMA), N,N-diethylaminoethyl methacrylate, N,N-dimethylaminoethyl acrylamide, N,N-dimethylaminoethyl methacrylamide, N,N-dimethylaminopropyl acrylamide, N,N-dimethylaminopropyl methacrylamide, vinylpyridine, vinylimidazole, and the like.

The above hydrophilic monomers may be used singly or in combination. From considerations of more effectively preventing the clouding described above and obtaining high flexibility and adhesive strength, the amount of hydrophilic monomer, if a hydrophilic monomer is used, is generally approximately 5 mass % or more and approximately 40 mass % or less, or approximately 10 mass % or more and approximately 30 mass % or less, based on the total monomer component mass.

The (meth)acrylic copolymer having a radiation reactive site can be formed by polymerizing the monomer components in the presence of a polymerization initiator. If, for example, the radiation reactive site has an ethylenically-unsaturated structure, a (meth)acrylic copolymer having a radiation reactive site can be formed by reacting a (meth)acrylic copolymer having a reactive group in a side chain thereof with a reactive (meth)acrylate. There is no particular limitation upon the polymerization method, and the monomer component can be polymerized by a normal radical polymerization method, such as solution polymerization, emulsion polymerization, suspension polymerization, bulk polymerization, or the like. In general, radical polymerization using a thermal polymerization initiator is employed so that the radiation reactive site does not react during polymerization. Examples of thermal polymerization initiators include organic peroxides such as benzoyl peroxide, t-butyl perbenzoate, cumene hydroperoxide, diisopropyl peroxy dicarbonate, di-n-propyl peroxy dicarbonate, di(2-ethoxyethyl) peroxy dicarbonate, t-butyl peroxy neodecanoate, t-butyl peroxy pivalate, (3,5,5-trimethyl hexanoyl) peroxide, dipropionyl peroxide, diacetyl peroxide, and the like; and azo type compounds such as 2,2′-azobis isobutyronitrile, 2,2′-azobis(2-methyl butyronitrile), 1,1′-azobis(cyclohexane-1-carbonitrile), 2,2′-azobis(2,4-dimethyl valeronitrile), 2,2′-azobis(2,4-dimethyl-4-methoxy valeronitrile), dimethyl 2,2′-azobis(2-methyl propionate), 4,4′ azobis(4-cyano valeric acid), 2,2′-azobis(2-hydroxymethyl propionitrile), 2,2′-azobis[2-(2-imidazolin-2-yl)propane], and the like.

The weight average molecular weight of the (meth)acrylic copolymer having a radiation reactive site is generally approximately 30,000 or more, or approximately 50,000 or more, or approximately 100,000 or more, and approximately 1,000,000 or less, or approximately 500,000 or less, or approximately 300,000 or less. The value for the weighted average molecular weight in the present disclosure is in terms of polystyrene equivalent as determined by gel permeation chromatography.

The glass transition temperature Tg of the (meth)acrylic copolymer having a radiation reactive site is generally approximately 40° C. or less, approximately 20° C. or less, or approximately 0° C. or less. The value for the glass transition temperature in the present disclosure is based on measuring the dynamic elastoviscosity.

### Plasticizer

The radiation curable pressure sensitive adhesive sheet according to an embodiment of the present disclosure contains a plasticizer capable of forming a bond with a (meth)acrylic copolymer having a radiation reactive site via irradiation. A radiation curable pressure sensitive adhesive sheet containing such a plasticizer has hot melt properties accompanied by high initial adhesion and good fluidity before UV irradiation, and high hardness (especially storage modulus) after irradiation. More typically, the radiation curable pressure sensitive adhesive sheet according to an embodiment of the present disclosure has improved hot melt properties before irradiation compared to a pressure sensitive adhesive sheet formed using a (meth)acrylic copolymer having a radiation reactive site alone, and has high hardness after radiation compared to a pressure sensitive adhesive sheet formed using a (meth)acrylic copolymer having a radiation reactive site alone.

One example of a structure capable of bonding with a (meth)acrylic copolymer having a radiation reactive site is an ethylenically-unsaturated structure. The plasticizer typically has two or more structures within the molecule capable of bonding with a (meth)acrylic copolymer having a radiation reactive site.

In a preferred embodiment, the plasticizer contains a polyfunctional (meth)acrylate. A polyfunctional (meth)acrylate is advantageous in terms of ability to bond with the (meth)acrylic copolymer having a radiation reactive site and miscibility with this (meth)acrylic copolymer. Examples of polyfunctional (meth)acrylates include difunctional acrylates such as ethoxylated bisphenol A diacrylate, propoxylated bisphenol A diacrylate, 1,10-decanediol diacrylate, tricyclodecane dimethylol diacrylate, ethoxylated 2-methyl-1,3-propanediol diacrylate, neopentyl glycol diacrylate, 2-hydroxy-3-acryloyloxypropyl acrylate, propoxylated ethoxylated bisphenol A diacrylate, 1,6-hexanediol diacrylate, 1,9-nonanediol diacrylate, dipropylene glycol diacrylate, tripropylene glycol diacrylate, and bis(acryloyloxyethyl)hydroxyethyl isocyanurate; difunctional methacrylates such as ethylene glycol dimethacrylate, diethylene glycol dimethacrylate, triethylene glycol dimethacrylate, tetraethylene glycol dimethacrylate, 1,3-butanediol dimethacrylate, 1,4-butanediol dimethacrylate, 1,6-hexanediol dimethacrylate, 1,9-nonanediol dimethacrylate, 2-methyl-1,8-octanediol dimethacrylate, ethoxylated bisphenol A dimethacrylate, neopentylglycol dimethacrylate, tricyclodecane dimethylol dimethacrylate, and glycerin dimethacrylate, tripropylene glycol dimethacrylate; trifunctional acrylates such as ethoxylated trimethylolpropane triacrylate, trimethylolpropane triacrylate, propoxylated trimethylolpropane triacrylate, pentaerythritol triacrylate, and tris(acryloyloxyethyl) isocyanurate; trifunctional methacrylates such as trimethylolpropane trimethacrylate and ethoxylated trimethylolpropane trimethacrylate; acrylates having four or more acryloyl groups such as ethoxylated pentaerythritol tetraacrylate, ditrimethylolpropane tetraacrylate, propoxylated pentaerythritol tetraacrylate, pentaerythritol tetraacrylate, and dipentaerythritol hexaacrylate; urethan acrylates having two or more acryloyl groups; poly-branched acrylates (for example, STAR-501, produced by Osaka Organic Chemical Industry Ltd.), and the like.

In a preferred embodiment, the plasticizer contains a ring structure. A plasticizer containing a ring structure is advantageous for tending to have low curing shrinkage, allowing internal stress in the cured pressure sensitive adhesive sheet to be reduced. A plasticizer containing a ring structure is also advantageous in tending to have a high Tg, increasing elastic modulus after curing. Examples of plasticizers containing a ring structure include tricyclodecane dimethanol diacrylate, tricyclodecane dimethanol dimethacrylate, bis(acryloyloxyethyl)hydroxyethyl isocyanurate, tris(acryloyloxyethyl) isocyanurate, ethoxylated bisphenol A diacrylate, ethoxylated bisphenol A dimethacrylate, and the like. From optical considerations, especially preferred examples include a tricyclodecane dimethanol diacrylate including a cycloaliphatic moiety within the ring structure, and tricyclodecane dimethanol dimethacrylate.

The plasticizer preferably has good miscibility with a (meth)acrylic copolymer having a radiation reactive site. Specifically, it is preferable that the phases of the (meth)acrylic copolymer and plasticizer mixture do not separate. An example of a preferred plasticizer enabling good miscibility to be obtained is the polyfunctional (meth)acrylate described above. If the (meth)acrylic copolymer having a radiation reactive site and the plasticizer have good miscibility, the radiation curable pressure sensitive adhesive sheet is capable of satisfactorily solving the problems of conventional pressure sensitive adhesive sheets. Specifically, the problem of reduced transparency in a pressure sensitive adhesive sheet arising from bleed-out or from microscopic or macroscopic phase separation in a pressure sensitive adhesive sheet formed from a conventional crosslinkable hot melt pressure sensitive adhesive, formed from a mixture of a thermoplastic base polymer not having a radiation reactive site and a monomeric crosslinkable component, can be satisfactorily solved using a radiation curable pressure sensitive adhesive sheet according to a specific embodiment of the present disclosure. In this case, the radiation curable pressure sensitive adhesive sheet is even more advantageous for having especially high transparency. High transparency is especially useful in applications demanding superior optical properties, such as for use with an image display device, touch panel, or the like.

From considerations of improved flow properties and adhesive properties, the amount of plasticizer in the radiation curable pressure sensitive adhesive sheet is preferably approximately 1 part by mass or more or approximately 5 parts by mass or more, and preferably approximately 20 parts by mass or less or approximately 10 parts by mass or less, relative to 100 parts by mass of (meth)acrylic copolymer having a radiation reactive site.

### Other Components

The radiation curable pressure sensitive adhesive sheet according to an embodiment of the present disclosure may contain other optional components apart from the (meth)acrylic copolymer having a radiation reactive site and the plasticizer described above. Examples of optional components include fillers, antioxidants, and the like.

In one embodiment, as in the case of, for example, a radiation curable pressure sensitive adhesive sheet containing a (meth)acrylic copolymer in which the radiation reactive site has an ethylenically-unsaturated structure, the pressure sensitive adhesive sheet contains a photoinitiator for radiation curing, and is cured via irradiation using UV light, visible light, electron beams, or other types of radiation.

Examples of photoinitiators include benzyl dimethyl ketal, 1-hydroxycyclohexyl phenylketone, 2-methyl-1-[4-(methylthio)phenyl]-2-morpholinopropane-1-on, 2-hydroxy-2-methyl-1-phenylpropane-1-on, 2-benzyl-2-dimethylamino-1-(4-morpholinophenyl)butane-1-on-1-[4-(2-hydroxyethoxy)-phenyl]-2-hydroxy-2-methyl-1-propane-1-on, bisacylphosphine oxide, acylphosphine oxide, 2,4,6-trimethylbenzoyl diphenylphosphine oxide, 2,6-dimethylbenzoyl diphenylphosphine oxide, benzoyl diethoxyphosphine oxide bis(2,6-dimethoxybenzoyl)-2,4,4-trimethylpentylphosphine oxide, benzoinalkyl ether (for example, benzoinmethyl ether, benzoinethyl ether, benzoinisopropyl ether, benzoinisobutyl ether, n-butylbenzoin ether, and the like), 1-(4-isopropylphenyl)-2-hydroxy-2-methylpropane-1-on, 2-hydroxy-2-methyl-1-phenylpropane-1-on, p-tert-butyl trichloro acetophenone, p-tert-butyl dichloro acetophenone, benzyl, benzoyl, acetophenone, benzophenone, thioxanthones (2-chloro thioxanthone, 2-methyl thioxanthone, 2,4-diethylthioxanthone, 2,4-diisopropyl thioxanthon), dibenzosuberone, 4,4′-dichlorobenzophenone, 4,4′-bis(dimethylamino)benzophenone, 4,4′-bis(diethylamino)benzophenone, 3,3′,4,4′-tetra(tert-butyl peroxycarbonyl)benzophenone, benzalacetone, biacetyl, α,α-dichloro-4-phenoxy acetophenone, tetramethylthiuram disulfide, α,α′-azo bisisobutyronitrile, benzoylperoxide, 3,3′-dimethyl-4-methoxybenzophenone, methylbenzoyl formate, 2,2-diethoxy acetophenone, acyloxime ester, acetophenone chloride, hydroxyacetophenone, acetophenone diethylketal, 4′-isopropyl-2-hydroxy-2-methylpropiophenone, methyl phenylglyoxylate, methyl 0-benzoylbenzoic acidbenzoate, methyl p-dimethylaminobenzoate, 2,2′-bis(0-chlorophenyl)-4,5,4′,5)-tetraphenyl-1,2′-biimidazole, 10-butyl-2-chloroacridone, camphorquinone, 3-ketocoumarin, anthraquinones (for example, anthraquinone, 2-ethylanthraquinone, α-chloroanthraquinone, 2-tert-butylanthraquinone, and the like), acenaphthene, 4,4′-dimethoxybenzyl, 4,4′-dichlorobenzyl, and the like. Examples of commercially available photoinitiators include those sold under the tradenames Irgacure and Darocur by BASF, and under the tradename Velsicur by Velsicol.

The above compounds can be used individually or in mixtures of two or more types. A photoinitiator and a sensitizer may also be used together. The amount of photoinitiator used is generally approximately 0.01 parts by mass or more and approximately 1 part by mass or less, based on 100 parts by mass of (meth)acrylic copolymer.

In another embodiment, as for example in the case of a UV crosslinkable pressure sensitive adhesive sheet containing a (meth)acrylic copolymer in which the radiation reactive site has a benzophenone structure, the (meth)acrylic copolymer is capable of being cured alone by irradiation. In this case, the use of a photoinitiator is optional.

A storage modulus of the pressure sensitive adhesive sheet before irradiation is preferably approximately 1.0×10⁴ Pa or more, or approximately 5.0×10⁴ Pa or more at 30° C. and 1 Hz, and preferably approximately 1.0×10⁶ Pa or less. If the storage modulus at 30° C. and 1 Hz is approximately 1.0×10⁴ Pa or more, the pressure sensitive adhesive sheet will have superior cohesion ability, and favorable properties such as workability, ease of handling, and shape maintenance are satisfactorily obtained. If the storage modulus at 30° C. and 1 Hz is approximately 1.0×10⁶ Pa or less, a satisfactory level of initial adhesiveness (namely, tack) needed to apply the pressure sensitive adhesive sheet will be obtained.

The storage modulus of the pressure sensitive adhesive sheet before irradiation at 80° C. and 1 Hz is preferably approximately 5.0×10⁴ Pa or less. If the storage modulus at 80° C. and 1 Hz is approximately 5.0×10⁴ Pa or less, the advantage is yielded that, when heated for application, the pressure sensitive adhesive sheet conforms to the three-dimensional surface topography of the adherend within a specific time (for example, from a few seconds to a few minutes) and is capable of flowing to prevent the formation of spaces in the vicinity thereof.

A storage modulus of the pressure sensitive adhesive sheet after irradiation at 30° C. and 1 Hz can be approximately 2.0×10⁶ Pa or more, or approximately 2.5×10⁶ Pa or more. If the storage modulus at 30° C. and 1 Hz of the pressure sensitive adhesive sheet is approximately 2.0×10⁶ Pa or more, the pressure sensitive adhesive sheet will have the advantages of a high hardness after irradiation, and a superior resistance against pressing by a stylus or the like, for example, when used with an image display module or optical member having a thin (for example, from 75 to 300 μm) surface protecting layer formed from a comparatively soft plastic resin.

Furthermore, the storage modulus of the pressure sensitive adhesive sheet after irradiation at 130° C. and 1 Hz is preferably approximately 1.0×10³ Pa or more, or approximately 1.0×10⁴ Pa or more. If the storage modulus at 130° C. and 1 Hz of the pressure sensitive adhesive sheet after irradiation is approximately 1.0×10³ Pa or more, flowing of the pressure sensitive adhesive sheet after curing will be suppressed, and a bond with good long-term reliability can be obtained. In particular, if the storage modulus of the pressure sensitive adhesive sheet after irradiation at 130° C. and 1 Hz is approximately 1.0×10⁴ Pa or more, a good bond will be obtained due to the hardness of the cured pressure sensitive adhesive sheet.

The storage modulus of the pressure sensitive adhesive sheet can be modified by varying the type, molecular weight, or proportion of the monomers constituting the (meth)acrylic copolymer contained in the pressure sensitive adhesive sheet, the degree of polymerization of the (meth)acrylic copolymer, the type and proportion of the plasticizer, and so on. For example, storage modulus tends to increase if an ethylenically-unsaturated monomer having an acid group is used. Likewise, storage modulus tends to decrease with increasing amounts of, for example, (meth)acrylic alkyl ester having from 2 to 26 carbon atoms in the alkyl group; (meth)acrylic hydroxyalkyl ester having no more than 4 carbon atoms in the alkyl group; (meth)acrylate containing an oxyethylene group, an oxypropylene group, an oxybutylene group, or a group in which a plurality of these are chained together; or (meth)acrylate having a carbonyl group in an alcohol residue. Increasing the degree of polymerization of the (meth)acrylic copolymer also tends to increase the storage modulus.

The thickness of the pressure sensitive adhesive sheet can be appropriately determined based on the application, and for example can be from approximately 5 μm to approximately 1 mm. One standard for determining the thickness of the pressure sensitive adhesive sheet is the height of the three-dimensional surface topography on the surface of the adherend. According to the pressure sensitive adhesive sheet according to one embodiment of the present disclosure, the thickness of the pressure sensitive adhesive sheet can be roughly the same as the height of the three-dimensional surface topography while suppressing deficiencies such as spaces, patchiness, or the like. In an embodiment in which the surface of the adherend is essentially flat, if the height of the three-dimensional surface topography on the surface of the adherend is determined with respect to the direction perpendicular to the spread out surface of the pressure sensitive adhesive sheet when applied to the adherend (namely, the thickness direction of the pressure sensitive adhesive sheet), the thickness of the pressure sensitive adhesive sheet can be approximately 0.8 times or more, approximately 1 times or more, or approximately 1.2 times or more and approximately 5 times or less, approximately 3 times or less, or approximately 2 times or less than the maximum thickness of the three-dimensional surface topography. Such a thickness will allow the thickness of the laminate including the adherend to be kept low, enabling, for example, decreased size and thickness in an image display device, or increased sensitivity in a touch panel. In one embodiment, a radiation curable pressure sensitive adhesive sheet can be applied to an adherend having a three-dimensional surface topography with a height of roughly 30 μm, the sheet having roughly the same thickness as the three-dimensional surface topography.

The pressure sensitive adhesive sheet can be formed from only a (meth)acrylic copolymer and a plasticizer, or from a mixture of a (meth)acrylic copolymer, a plasticizer, and an optional component using a conventionally known method such as solution casting, an extruding process, or the like. Furthermore, the pressure sensitive adhesive sheet can have a release film such as a silicone treated polyester film, polyethylene film, or the like, on one side or both sides thereof.

The radiation curable pressure sensitive adhesive sheet according to an embodiment of the present disclosure can be favorably used in a variety of applications, such as with an image display module or an optical member. An example of a desirable application is bonding a surface protecting layer formed from thin polyester and having a raised ink section to a touch panel.

Another embodiment of the present disclosure is a laminate including a substrate and the radiation curable pressure sensitive adhesive sheet described above. Examples of substrate include surface protecting layers, image display modules, and touch panels. Such a laminate can be used as a member constituting a part of products for various types of applications such as image display modules, optical members, and the like. Such a laminate can typically be manufactured using a method including steps of disposing a radiation curable pressure sensitive adhesive sheet adjacent to a substrate, heating and/or pressurizing the radiation curable pressure sensitive adhesive sheet, and irradiating a radiation on the radiation curable pressure sensitive adhesive sheet.

Another embodiment of the present disclosure is a laminate including a first substrate, a second substrate, and the above radiation curable pressure sensitive adhesive sheet disposed between the first substrate and the second substrate, wherein at least one surface of the first substrate is in contact with the radiation curable pressure sensitive adhesive sheet. Various configurations of the laminate are possible. For example, the first substrate can be a surface protecting layer, and the second substrate can be an image display module or touch panel.

The present disclosure is especially useful when at least one of the first substrate and the second substrate has a three-dimensional surface topography such as a raised section, protuberance, or the like on the surface adhering to the pressure sensitive adhesive sheet.

The present disclosure is also especially useful in cases where at least one of the first substrate and the second substrate is distortion sensitive. In the context of the present disclosure, “distortion sensitive” means that decreases in performance are liable to result from warping, and refers to, for example, the tendency of color patches to form in an LCD due to distortion. In particular, substrates that are distortion sensitive readily exhibit optical distortion arising from localized stress in that substrate. Examples of substrates that are distortion sensitive include LCDs, active matrix organic light-emitting diode (AMOLED) displays, 3D lenses used in 3D image displays such as 3D televisions, and the like.

The laminate according to the present embodiment can typically be manufactured using a method including steps of disposing a radiation curable pressure sensitive adhesive sheet adjacent to at least one surface of a first substrate, disposing a second substrate adjacent to the radiation curable pressure sensitive adhesive sheet, heating and/or pressurizing the radiation curable pressure sensitive adhesive sheet, and irradiating a radiation on the radiation curable pressure sensitive adhesive sheet. The order of the steps is not restricted to the above order. For example, a method in which a pressure sensitive adhesive sheet is sandwiched between a first substrate and a second substrate and then heated and/or pressurized; or a method in which a pressure sensitive adhesive sheet disposed adjacent to a first substrate is heated and/or pressurized, and a second substrate is then disposed adjacent to the pressure sensitive adhesive sheet, can be employed.

Another embodiment of the present disclosure is a method of manufacturing a laminate including a first substrate, a second substrate, and the radiation curable pressure sensitive adhesive sheet described above, which is disposed between the first substrate and the second substrate,

wherein at least one of the first substrate and the second substrate has a three-dimensional surface topography extending over at least a portion of a major surface thereof; the method including the steps of:

disposing the radiation curable pressure sensitive adhesive sheet adjacent to at least one surface of the first substrate;

disposing the second substrate adjacent to the radiation curable pressure sensitive adhesive sheet;

heating and/or pressurizing the radiation curable pressure sensitive adhesive sheet to conform to the three-dimensional surface topography; and

irradiating a radiation on the radiation curable pressure sensitive adhesive sheet.

In the method according to the present embodiment, the pressure sensitive adhesive sheet is disposed adjacent to a substrate so that the pressure sensitive adhesive sheet will contact and conform to the three-dimensional surface topography of the substrate when heated and/or pressurized. According to the above method, the vicinity of the three-dimensional surface topography can be filled by the pressure sensitive adhesive sheet, and the formation of spaces in the vicinity of the three-dimensional surface topography is suppressed. More specifically, the good fluidity of the pressure sensitive adhesive sheet alleviates internal stress in the pressure sensitive adhesive sheet on the surface of the substrate having the three-dimensional surface topography, and the laminate can be formed with good wetting properties. While not limited thereto, an example of the configuration of a laminate to which the above method is applied is one in which the first substrate is a surface protecting layer having a three-dimensional surface topography such as a raised section or a protuberance, and the second substrate is an image display module or touch panel having or lacking such a three-dimensional surface topography. The order of the steps in the above method is not limited to that given above.

In one example, after a pressure sensitive adhesive sheet is sandwiched between a first substrate and a second substrate, the pressure sensitive adhesive sheet is heated and/or pressurized. This example has the advantage that the formation of spaces in the vicinity of the three-dimensional surface topography can be prevented and a good bond obtained both in cases where one of the first substrate and the second substrate has a three-dimensional surface topography on an adhering surface as well as in cases where both the first substrate and the second substrate have a three-dimensional surface topography on an adhering surface. An example of a configuration in which both the first substrate and the second substrate have a three-dimensional surface topography is a configuration in which the first substrate is a surface protecting layer and the second substrate is a polarizing plate (to which the pressure sensitive adhesive sheet is applied) attached to an image display module.

In this example, the pressure sensitive adhesive sheet is first disposed adjacent to at least one surface of the first substrate, and the second substrate is disposed adjacent to the pressure sensitive adhesive sheet. At this point, the pressure sensitive adhesive sheet is sandwiched between the first substrate and the second substrate so that the three-dimensional surface topography faces toward the pressure sensitive adhesive sheet. Next, the pressure sensitive adhesive sheet is heated and/or pressurized, and the pressure sensitive adhesive sheet is conformed to the three-dimensional surface topography. Next, the pressure sensitive adhesive sheet is irradiated with radiation through these substrates from the first substrate and/or second substrate side to cure the pressure sensitive adhesive sheet. By conforming the pressure sensitive adhesive sheet to the three-dimensional surface topography of the first substrate and/or the second substrate in this way, the first substrate and second substrate can be bonded without spaces forming in the vicinity of the three-dimensional surface topography.

In the above example, at least one of the first substrate and the second substrate is at least partially transparent so that the pressure sensitive adhesive sheet can be irradiated with the radiation needed for curing. For example, if one of the first substrate and the second substrate has a three-dimensional surface topography, and the three-dimensional surface topography does not transmit radiation, the radiation will not be transmitted directly below the three-dimensional surface topography part when irradiation of the radiation is performed from the side of the substrate having the three-dimensional surface topography; however, curing of the pressure sensitive adhesive sheet even in non-irradiated parts will still progress to some extent due to the movement of radicals formed in the irradiated parts. In such cases, if the substrate not having a three-dimensional surface topography is a transparent substrate such as a touch panel, it is possible to irradiate the radiation on the part of the pressure sensitive adhesive sheet corresponding to the three-dimensional surface topography part by irradiating the radiation from the side of the substrate not having a three-dimensional surface topography, enabling more even curing of the pressure sensitive adhesive sheet.

Another embodiment of the present disclosure is a method of manufacturing a laminate including a first substrate, a second substrate, and the radiation curable pressure sensitive adhesive sheet described above,

wherein at least one of the first substrate and the second substrate is distortion sensitive; the method including the steps of:

disposing the radiation curable pressure sensitive adhesive sheet adjacent to at least one surface of the first substrate;

disposing the second substrate adjacent to the radiation curable pressure sensitive adhesive sheet;

heating and/or pressurizing the radiation curable pressure sensitive adhesive sheet; and

irradiating a radiation on the radiation curable pressure sensitive adhesive sheet.

An example of a substrate that is distortion sensitive is as described above.

The order of the steps in the present embodiment is not limited to that given above. In one example, after a pressure sensitive adhesive sheet is sandwiched between a first substrate and a second substrate, the pressure sensitive adhesive sheet is heated and/or pressurized. In another example, a pressure sensitive adhesive sheet is disposed adjacent to a first substrate that is distortion sensitive or that is not distortion sensitive, the open face of the pressure sensitive adhesive sheet is heated and/or pressurized, and a second substrate that is distortion sensitive is disposed adjacent to the pressure sensitive adhesive sheet. The pressure sensitive adhesive sheet according to the present disclosure has good fluidity and flexibility before curing. This yields the advantage that the application of excessive stress to the substrate when the sheet is bonded to a substrate that is distortion sensitive can thereby be prevented, and a bond alleviating internal stress is possible. The above advantage is especially pronounced when the pressure sensitive adhesive sheet is applied to a substrate that is distortion sensitive after being subjected to heat and/or pressure.

The various steps in the present embodiment can be performed in the same order as given in the above embodiment using a substrate having a three-dimensional surface topography.

In the step of heating and/or compressing the pressure sensitive adhesive sheet of the present disclosure, the heating and/or compressing can be performed using a convection oven, hot plate, heat press, heat laminator, autoclave, or the like. In order to enhance the fluidity of the pressure sensitive adhesive sheet so that the pressure sensitive adhesive sheet will more efficiently track the shape of the substrate, compressing is preferably performed at the same time as heating, using a heat laminator, heat press, autoclave, or the like. Compressing with an autoclave is particularly advantageous for removing bubbles from the pressure sensitive adhesive sheet. The heating temperature of the pressure sensitive adhesive sheet can be a temperature where the pressure sensitive adhesive sheet softens or flows to sufficiently track the contour of the shape of the substrate, and generally can be approximately 30° C. or higher, approximately 40° C. or higher, or approximately 60° C. or higher, and approximately 150° C. or lower, approximately 120° C. or lower, or approximately 100° C. or lower. If pressure is applied to the pressure sensitive adhesive sheet, the applied pressure generally can be approximately 0.05 MPa or more or approximately 0.1 MPa or more, and approximately 2 MPa or less or approximately 1 MPa or less.

In the step of irradiating the pressure sensitive adhesive sheet, UV light, visible light, electron beams, or the like can be used as the radiation. If UV light is used, irradiation can be performed using a general UV irradiation apparatus, such as a belt conveyor type ultraviolet light irradiating device that uses low-pressure mercury lamps, moderate pressure mercury lamps, high-pressure mercury lamps, ultra-high-pressure mercury lamps, xenon lamps, metal halide lamps, electrode free lamps, LED, and the like as light sources. In this case, the amount of UV irradiation is generally approximately 1,000 mJ/cm² to approximately 5,000 mJ/cm².

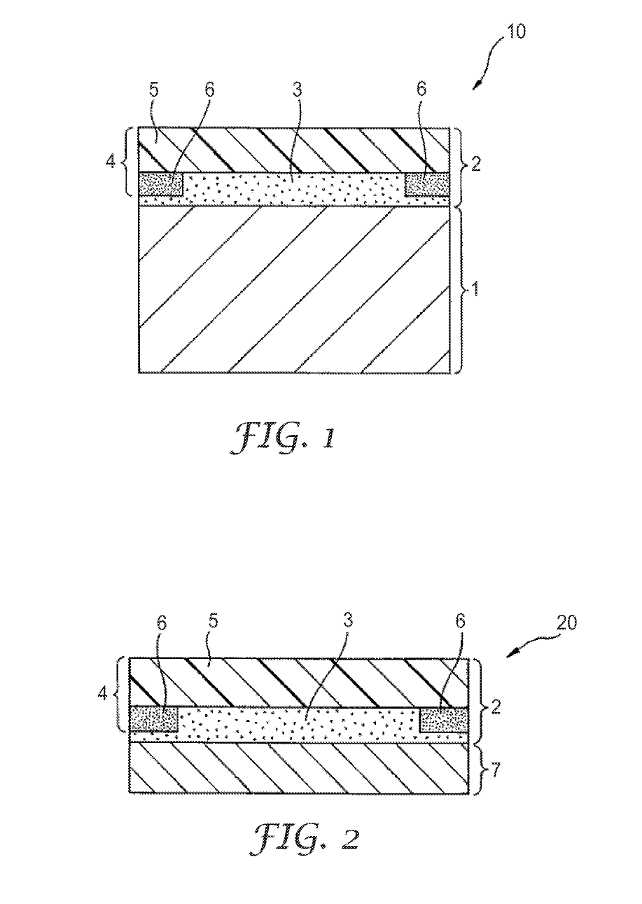

For exemplary purposes, an embodiment in which the first substrate is a surface protecting layer having a raised section as a three-dimensional surface topography on the surface and the second substrate is an image display module or touch panel will be described with reference to FIGS. 1 and 2.

The surface protecting layer is disposed on the outermost surface of the image display module or touch panel, and protects the same from the exterior. The surface protecting layer can be any layer conventionally used as a protective material for an image display module or touch panel, examples thereof including films of acrylic resins such as polymethyl methacrylate (PMMA), polycarbonate resin films, films of polyester resins such as polyethylene terephthalate (PET), or a sheet of glass. While not limited thereto, an example of the thickness of the film or glass sheet is from approximately 0.1 mm to approximately 5 mm.

A layer for imparting functions or properties such as wear resistance, abrasion resistance, stain resistance, anti-reflective properties, static resistance, or the like can be provided on the surface protecting layer on the viewer side of an image display module or the user side of a touch panel. A layer for imparting wear resistance and abrasion resistance can be formed by applying and curing a curable resin composition capable of forming a hard coating. For example, a coating material consisting of colloidal silica and partial condensation products of a silane mixture, the primary component of which is alkyl trialkoxysilane, can be applied, and then heat-cured to create a cured coating; or a coating material, the primary component of which is a poly-functional acrylate, can be applied, and then cured using UV irradiation to form a cured coating. In order to ensure stain resistance, a resin layer containing an organosilicon compound, a fluoride compound, or the like can be formed. In order to obtain static resistance, a resin layer containing a surfactant, conductive particles, and the like can be formed. The layer for imparting these functions or properties preferably will not impede the transparency of the surface protecting layer, and is preferably as thin as possible, within the extent that the functions of the layer can be demonstrated. The thickness of the function-imparting or property-imparting layer is generally from approximately 0.05 μm to approximately 10 μm, but is not limited thereto.

The embodiment described here has an additional printed layer, deposited layer, or the like on part of the surface of the surface protecting layer adjacent to the pressure sensitive adhesive sheet, and a raised section is formed on this surface of the surface-protecting layer. The printed layer or deposited layer is formed, for example, in a frame-like shape on an exterior periphery of the image display module and functions as a light-blocking layer concealing that area from view. The thickness of the printed layer or deposited layer used as such a light-blocking layer is generally from approximately 10 μm to approximately 20 μm if the layer is a black color having high light blocking effects, or from approximately 40 μm to approximately 50 μm if the layer is white or another color readily transmitting light.

Examples of the image display module include, but are not limited to, reflective and back-lit LCD units, plasma display units, electroluminescence (EL) displays, electronic paper, and the like. The display surface of the image display module can have additional layers (one layer or multiple layers) such as a light polarizing plate (which may have a surface with recesses and protrusions) for example. A touch panel as described below may also be present on the display surface of the image display module.

Touch panels are transparent thin-film shaped devices, whereby when a user touches or presses a certain position on the touch panel using a finger or pen (stylus), that position can be detected and specified. Furthermore, when a plurality of points are simultaneously touched, motions such as the subject movements, rotation, image zoom, and the like can be directly input. The position detection method is generally a resistance film method that is operated by the pressure applied on the touch panel, an electrostatic capacitance method that detects the change in electrostatic capacitance between the fingertip and the touch pane, or the like. The touch panel is provided on an image display device such as a CRT display, a liquid crystal display, or the like, and is used in ATMs, PCs (personal computer), mobile terminals such as mobile phones, and portable devices such as PDAs and the like.

FIG. 1 is a cross-sectional view of one embodiment of an image display device in the form of a laminate including a radiation curable pressure sensitive adhesive sheet. An image display device 10 has a structure in which a pressure sensitive adhesive sheet 3 and a surface protecting layer 4 are laminated in that order upon the surface of an image display module 1. The surface protecting layer 4 is constituted by a continuous layer 5 and a light-blocking layer 6 (on the pressure sensitive adhesive sheet 3 side) provided in a partial portion of the undersurface of the continuous layer 5, and a raised section is formed on the surface thereof. The light-blocking layer 6 is formed by blending a colorant into a curable resin composition coating solution, applying the coating to a specific area of the continuous layer 5 using screen printing or another suitable method, and curing the coating using UV irradiation or another suitable curing method. The pressure sensitive adhesive sheet 3 is applied to a surface of a surface protecting layer 4 having a raised section. Because the pressure sensitive adhesive sheet 3 is heated and/or pressurized before curing, the sheet sufficiently conforms to the raised section formed in the light-blocking layer 6, and no spaces are formed in the vicinity of the raised section. Also, because the remaining internal stress of the pressure sensitive adhesive sheet is alleviated, display deformation in the image display device can be prevented. The image display device 10 is obtained by applying a laminate 2, for example, formed from the surface protecting layer 4 and the pressure sensitive adhesive sheet 3, to the image display module 1.

FIG. 2 is a cross-sectional view of one embodiment of a touch panel unit in the form of a laminate including a radiation curable pressure sensitive adhesive sheet. A touch panel unit 20 has a structure in which a pressure sensitive adhesive sheet 3 and a surface protecting layer 4 are laminated in that order upon the surface of a touch panel 7. The structure of a laminate 2, in which the pressure sensitive adhesive sheet 3 and surface protecting layer 4 are layered in that order, is the same as that shown in FIG. 1. Because the pressure sensitive adhesive sheet 3 is heated and/or pressurized before curing, the sheet sufficiently conforms to the raised section formed in the light-blocking layer 6, and no spaces are formed in the vicinity of the raised section. The touch panel unit 20 is obtained by applying the laminate 2, for example, formed from the surface protecting layer 4 and the pressure sensitive adhesive sheet 3 to the touch panel 7. An image display module (not illustrated) having a display surface on an upper side may also be attached on an underside of the touch panel 7 either directly or with another pressure sensitive adhesive sheet therebetween.

In yet another embodiment of the present disclosure, an electronic apparatus that includes the aforementioned image display module is provided. These electronic devices are not restricted to the following, but examples include mobile phones, personal digital assistant (PDA), portable game devices, electronic book terminals, car navigation systems, portable music players, watches, televisions (TV), video cameras, video players, digital cameras, global positioning system (GPS) devices, personal computers (PC), and the like.

### EXAMPLES

The present invention is described in further detail hereafter using examples, but the present invention is not limited by these examples.

### Monomer and Initiator Abbreviations

2-EHA: 2-ethylhexyl acrylate

ISTA: isostearyl acrylate (available from Osaka Organic Chemical Industry Ltd.)

AA: acrylic acid

AEBP: 4-acryloyloxyethoxy benzophenone

DCP-A: tricyclodecane dimethanol diacrylate

DCP-M: tricyclodecane dimethanol dimethacrylate

SR-399: dipentaerythritol pentaacrylate (available from Sartomer)

V-65: thermal initiator (2,2′-azole bis(2,4-dimethyl valeronitrile) (available from Wako Pure Chemical Industries, Ltd.)

MOI: 2-isocyanatoethyl methacrylate (available from Showa Denko)

TPO: 2,4,6-trimethylbenzoyl diphenylphosphine oxide

EtOAc: ethyl acetate

MEK: methyl ethyl ketone

### Fabrication Procedures

### Fabrication Example 1

A pressure sensitive adhesive sheet (PSA sheet 1) was fabricated as follows. An acrylic copolymer of a monomer containing an acrylic ester having a UV crosslinkable site as a radiation reactive site was synthesized. 4-acryloyloxyethoxy benzophenone was used as the acrylic ester having a UV crosslinkable site.

A mixture of 2-EHA/ISTA/AA/AEBP at ratios of 37.5:50.0:12.5:0.95 (by mass) was prepared, and then diluted with an ethyl acetate/methylethyl ketone (EtOAc:MEK=20 mass %:80 mass %) mixed solvent to obtain a monomer concentration of 45 mass %. Next, V-65 was added as an initiator at an amount of 0.2 mass % with respect to the monomer component mass and the system was nitrogen purged for 10 minutes. A reaction was induced for 24 hours in a constant temperature bath at 50° C. to obtain a transparent viscous solution. The weight average molecular weight of the obtained acrylic copolymer (polymer 1) was 210,000 (polystyrene equivalent as determined by gel permeation chromatography).

Subsequently, DCP-A was added to the obtained polymer solution. A ratio of solid polymer components to DCP-A was adjusted to 95:5 (mass).

Subsequently, the obtained solution was applied to a 50 μm thick release film (tighter side of Cerapeel MIB (T); produced by Toray Advanced Film) using a knife coater adjusted to a gap of 220 μm, and then dried for eight minutes in an oven at 100° C. The thickness of the dried pressure sensitive adhesive was 50 μm. Next, a 38 μm thick release film (Purex (R) A-31; available from Teijin Dupont Film) was laminated onto the surface of the pressure sensitive adhesive to obtain a pressure sensitive adhesive sheet (transfer adhesive tape) (PSA sheet 1).

### Fabrication Example 2

A transfer adhesive tape (PSA sheet 2) was fabricated in the same manner as PSA sheet 1, except that the ratio of solid polymer components to DCP-A was adjusted to 90:10 (by mass).

### Fabrication Example 3

A transfer adhesive tape (PSA sheet 3) was fabricated in the same manner as PSA sheet 1, except that the ratio of solid polymer components to DCP-A was adjusted to 85:15 (by mass).

### Fabrication Example 4

An adhesive transfer tape (PSA sheet 4) was fabricated in the same manner as PSA sheet 1, except that DCP-M was used at a ratio of solid polymer components to DCP-M of 90:10 (by mass).

### Fabrication Example 5

A PSA sheet 5 was fabricated as follows.

First, an acrylic copolymer containing an acrylic ester was synthesized. A mixture of 2-EHA/ISTA/AA at a ratio of 37.5:50.0:12.5 (by mass) was prepared, and then diluted with an ethyl acetate/methylethyl ketone (EtOAc:MEK=20 mass %:80 mass %) mixed solvent to obtain a monomer concentration of 45 mass %. Next, V-65 was added as an initiator at an amount of 0.2 mass % with respect to the monomer component mass. The system was then nitrogen purged for ten minutes. A reaction was induced for 24 hours in a constant temperature bath at 50° C. to obtain a transparent viscous solution. The weight average molecular weight of the obtained acrylic copolymer (polymer 2) was 270,000.

Next, MOI was added to the obtained polymer solution to introduce a methacryloyl group into the polymer structure. Reaction of the isocyanate of the MOI was performed by aging for 24 hours at 23° C. The solid polymer component/MOI ratio was adjusted to 100 mass %:0.5 mass %. Next, a solution of an acrylic copolymer having a methacryloyl group (polymer 3) was obtained.

Next, DCP-A and TPO were added to the obtained polymer solution. The polymer solid component/DCP-A/TPO ratio was adjusted to 95:5:0.5 (by mass).

Subsequently, the obtained solution was applied to a 50 μm thick release film (tighter side of Cerapeel MIB (T); produced by Toray Advanced Film) using a knife coater adjusted to a gap of 220 μm, and then dried for eight minutes in an oven at 100° C. The thickness of the dried pressure sensitive adhesive was 50 μm. Next, a 38 μm thick release film (Purex (R) A-31; available from Teijin Dupont Film) was laminated onto the surface of the pressure sensitive adhesive to obtain a pressure sensitive adhesive sheet (transfer adhesive tape) (PSA sheet 5).

### Comparative Fabrication Example 1

An adhesive transfer tape (PSA sheet 6) was fabricated in a manner identical to PSA sheet 1, except that the polymer 1 solution was applied directly without being mixed with any other components.

### Comparative Fabrication Example 2

TPO was added to the polymer 3 solution to obtain a solid polymer component/TPO ratio of 100:0.5 (by mass), and a coating thereof was applied so to fabricate an adhesive transfer tape (PSA sheet 7) according to the same procedure used for PSA sheet 1.

### Comparative Fabrication Example 3

DCP-A and TPO were added to the polymer 2 solution to yield a solid polymer component/DCP-A/TPO ratio of 95:5:0.5 (by mass), and a coating thereof was applied to fabricate an adhesive transfer tape (PSA sheet 8) according to the same procedure used for PSA sheet 1.

### Peel Strength (Adhesion Test)

### Examples 1 to 5 and Comparative Examples 1 and 2

A sample for an adhesion test was fabricated as follows.

The release film was peeled off the pressure sensitive adhesive sheet, and the exposed pressure sensitive adhesive was applied to anodized aluminum tape (width 30 mm). The thickness of the aluminum tape was 135 μm. Next, the remaining release film was peeled off, and the exposed pressure sensitive adhesive was applied to a 50 μm-thick unprocessed polyester (PET) film (Lumirror T60; available from Toray). The sample was pressed in two directions using a rubber roller (2,000 g), and left to stand at room temperature for 30 minutes.

The PET side of the sample was affixed to a sheet of stainless steel using double-sided tape. Adhesive strength was measured in terms of peeling at a peel rate of 300 mm/min at 90° C. by peeling the pressure sensitive adhesive supported by the aluminum tape from the PET. Results are shown in Table 1.

TABLE 1
Table 1: Peel strength of pressure sensitive adhesive sheet

| | | | Peel |
|---|---|---|---|
| Sample | | Compound | strength |
| Number | PSA | (proportion) | (N/25 mm) |
| Example 1 | PSA Sheet - 1 | Polymer 1/DCP-A = | 10.4 |
| | | 95/5 | |
| Example 2 | PSA Sheet - 2 | Polymer 1/DCP-A = | 12.6 |
| | | 90/10 | |
| Example 3 | PSA Sheet - 3 | Polymer 1/DCP-A = | 8.5 |
| | | 85/15 | |
| Example 4 | PSA Sheet - 4 | Polymer 1/DCP-M = | 11.8 |
| | | 90/10 | |
| Example 5 | PSA Sheet - 5 | Polymer 3/DCP-A/ | 13.0 |
| | | TPO-95/5/0.5 | |
| Comparative | PSA Sheet - 6 | Polymer 1 only | 6.3 |
| Example 1 | | | |
| Comparative | PSA Sheet - 7 | Polymer 3/TPO = | 8.3 |
| Example 2 | | 100/0.5 | |

As can be seen from Table 1, the peel strength of the pressure sensitive adhesive sheet fabricating using DCP-A or DCP-M along with an acrylic copolymer was greater than that of a pressure sensitive adhesive sheet fabricated using only an acrylic copolymer.

### (UV Irradiation Conditions)

The pressure sensitive adhesive sheet was irradiated with UV light through the release film using an F-300 UV irradiation apparatus (H bulb, 120 W/cm, 15 mpm×15 passes) manufactured by Fusion UV Systems, Inc. Total UV energy as measured using an EIT UV Power Puck (R) II was 1,940 mJ/cm² for UV-A (from 320 to 390 nm), and 74 mJ/cm² for UV-B (from 280 to 320 nm).

### Fluidity/Conformability and Storage Modulus (Dynamic Mechanical Analysis) of Pressure Sensitive Adhesive Sheet Before and after UV Irradiation

### Examples 6 to 10 and Comparative Examples 3 and 4

In order to evaluate the relative fluidity/conformability and storage modulus of the pressure sensitive adhesive sheet before UV irradiation and after UV irradiation, dynamic mechanical analysis (DMA) of the pressure sensitive adhesive sheet was performed using an ARES dynamic viscoelastometer (manufactured by TA Instruments). Test samples were fabricated by punching out samples with an 8 mm φ punch from irradiated and un-irradiated pressure sensitive adhesive sheets that had been layered to a thickness of approximately 3 mm, and these were used for the measurement. The measurement was performed in shear mode (1 Hz) over a temperature range of −40° C. to 200° C. at a temperature increase rate of 5° C./min. Results for storage modulus (G′) are shown in Table 2.

TABLE 2
Storage modulus of pressure sensitive adhesive sheet before and after UV irradiation

| Sample | | Compound | G′ Before ultraviolet irradiation (Pa) | | | | | | G′ After ultraviolet irradiation (Pa) | | | | | |
|---|---|---|---|---|---|---|---|---|---|---|---|---|---|---|
| Number | PSA | (proportion) | 20° C. | 30° C. | 80° C. | 100° C. | 120° C. | 130° C. | 20° C. | 30° C. | 80° C. | 100° C. | 120° C. | 130° C. |
| Example | PSA | Polymer | 7.7E+05 | 2.8E+05 | 1.3E+04 | 4.5E+03 | 1.1E+03 | 5.4E+02 | 1.2E+07 | 4.1E+06 | 7.5E+04 | 4.0E+04 | 2.6E+04 | 2.3E+04 |
| 6 | Sheet-1 | 1/DCP- | | | | | | | | | | | | |
| | | A = 95/5 | | | | | | | | | | | | |
| Example | PSA | Polymer | 4.5E+05 | 1.9E+05 | 9.4E+03 | 2.7E+03 | 5.4E+02 | 2.1E+02 | 2.0E+07 | 7.4E+06 | 1.5E+05 | 8.4E+04 | 6.9E+04 | 7.0E+04 |
| 7 | Sheet-2 | 1/DCP- | | | | | | | | | | | | |
| Example | PSA | A = 90/10 | | | | | | | | | | | | |
| 8 | Sheet-3 | Polymer | 2.8E+05 | 1.2E+05 | 5.8E+03 | 1.4E+03 | 2.1E+02 | 8.1E+01 | 3.9E+07 | 1.7E+07 | 3.6E+05 | 2.0E+05 | 2.0E+05 | 2.1E+05 |
| | | 1/DCP- | | | | | | | | | | | | |
| | | A = 85/15 | | | | | | | | | | | | |
| Example | PSA | Polymer | 5.3E+05 | 2.1E+05 | 9.9E+03 | 2.8E+03 | 5.7E+02 | 2.3E+02 | 2.6E+07 | 1.0E+07 | 2.5E+05 | 1.5E+05 | 1.1E+05 | 1.0E+05 |
| 9 | Sheet-4 | 1/DCP- | | | | | | | | | | | | |
| | | M = 90/10 | | | | | | | | | | | | |
| Example | PSA | Polymer | | | | | | | | | | | | |
| 10 | Sheet-5 | 3/DCP- | | | | | | | | | | | | |
| | | A/TPO = | 8.0E+05 | 3.0E+05 | 1.4E+04 | 4.6E+03 | 1.2E+03 | 5.6E+02 | 8.3E+06 | 2.9E+06 | 8.9E+04 | 5.6E+04 | 4.6E+04 | 4.5E+04 |
| | | 95/5/0.5 | | | | | | | | | | | | |
| Compa- | PSA | Polymer | 2.6E+06 | 8.2E+05 | 2.6E+04 | 1.0E+04 | 3.6E+03 | 1.9E+03 | 5.3E+06 | 1.6E+06 | 5.0E+04 | 2.8E+04 | 1.9E+04 | 1.6E+04 |
| rative | Sheet-6 | 1 only | | | | | | | | | | | | |
| Example 3 | | | | | | | | | | | | | | |
| Compa- | PSA | Polymer | 2.0E+06 | 5.9E+05 | 2.3E+04 | 8.0E+03 | 2.4E+03 | 1.1E+03 | 4.4E+06 | 1.3E+06 | 5.6E+04 | 3.4E+04 | 2.7E+04 | 2.6E+04 |
| rative | Sheet-7 | 3/TPO = | | | | | | | | | | | | |
| Example 4 | | 100/0.5 | | | | | | | | | | | | |

As can be seen from the results in Table 2, the storage modulus of PSA sheet 6 and PSA sheet 7 before UV irradiation was relatively greater than that of PSA sheets 1 through 5 (mixed systems of polymer/DCP-A or DCP-M). On the other hand, the storage modulus of PSA sheet 6 and PSA sheet 7 after UV irradiation was relatively lower than that of PSA sheets 1 through 5. Thus, the mixed systems allow both good fluidity before UV irradiation and sufficient hardness after to UV irradiation to be obtained.

### Pressing Resistance

### Examples 11 Through 13 and Comparative Examples 5 and 6

First, a laminate was fabricated as follows.

### Example 11

A release film of PSA sheet 3 was peeled off, and the PSA sheet 3 was applied to a 188 μm PET (Ester Film E-5101; available from Toyobo Co., Ltd.). Next, the other release film was removed, and the PSA sheet 3 was applied to a sheet of glass to fabricate a laminate (PET/pressure sensitive adhesive sheet/glass).

Next, UV irradiation was performed using an F-300 UV irradiation apparatus (H bulb, 120 W/cm) manufactured by Fusion UV Systems, Inc. from the PET side of the laminate. The total UV energy penetrating the PET film was 3,885 mJ/cm² for UV-A (from 320 to 390 nm) and 140 mJ/cm² for UV-B (from 280 to 320 nm). Visual confirmation of deformations was performed as follows.

A polyacetal stylus (radius of curvature R=0.8 mm) was brought into perpendicular contact with the PET side of the laminate. A 500 g weight was placed on top of the stylus for five seconds. Traces of deformation on the PET surfaces were observed by the unaided eye immediately (within a few seconds) after the stylus was removed, and the size of the traces was evaluated. The results are shown in Table 3.

### Example 12

Fabrication and evaluation of a laminate were performed as for example 11, except that PSA sheet 4 was substituted for PSA sheet 3. The results are shown in Table 3.

### Example 13

Fabrication and evaluation of a laminate were performed as for example 11, except that PSA sheet 5 was substituted for PSA sheet 3. The results are shown in Table 3.

### Comparative Example 5

Fabrication and evaluation of a laminate were performed as for example 11, except that PSA sheet 6 was substituted for PSA sheet 3. The results are shown in Table 3.

### Comparative Example 6

Fabrication and evaluation of a laminate were performed as for example 11, except that PSA sheet 7 was substituted for PSA sheet 3. The results are shown in Table 3.

TABLE 3
Table 3: Pressing resistance of pressure sensitive adhesive sheet

| Sample | | Compound | | |
|---|---|---|---|---|
| Number | PSA | (proportion) | Trace size | |
| Example 11 | PSA Sheet - 3 | Polymer 1/DCP-A = | <0.5 | mm^{a} |
| | | 85/15 | | |
| Example 12 | PSA Sheet - 4 | Polymer 1/DCP-M = | <0.5 | mm^{a} |
| | | 90/10 | | |
| Example 13 | PSA Sheet - 5 | Polymer 3/DCP-A/ | <0.5 | mm^{a} |
| | | TPO = 95/5/0.5 | | |
| Comparative | PSA Sheet - 6 | Polymer 1 only | =1.5-2.0 | mm^{a} |
| Example 5 | | | | |
| Comparative | PSA Sheet - 7 | Polymer 3/TPO = | =1.5-2.0 | mm^{a} |
| Example 6 | | 100/0.5 | | |

^{a}Traces dissipated immediately after the stylus was lifted

As can be seen from the results in Table 3, the relative size of the traces on PSA sheet 6 and PSA sheet 7 was greater than that of those on PSA sheets 1 through 5 (mixed systems of polymer/DCP-A or DCP-M). Thus, the mixed systems allow good scratch resistance to be obtained.

### Holding Power

### Example 14 and Comparative Example 7

First, a laminate was fabricated as follows.

### Example 14

PSA sheet 5 was cut to 25 mm×25 mm and applied to a 30 mm×60 mm×2 mm thickness sheet of glass after the release film on one side was removed. Next, the other release film was removed and applied to a 30 mm×60 mm×2 mm thickness sheet of glass to create a laminate (glass/pressure sensitive adhesive sheet/glass).

Next, treatment was performed for 30 minutes at 0.5 MPa and 60° C. using an autoclave. After the laminate was removed from the autoclave, UV irradiation was performed from one glass side using an F-300 UV irradiation apparatus (H bulb, 120 W/cm) manufactured by Fusion UV Systems. The total UV energy penetrating the glass was 1,908 mJ/cm² for UV-A (from 320 to 390 nm) and 20 mJ/cm² for UV-B (from 280 to 320 nm).

Subsequently, the laminate was suspended in an oven heated to 80° C. using a jig so that the glass surfaces were perpendicular with the floor surface, and a weight was placed on one of the glass sheets so that a weight of 200 g was applied parallel to the glass surfaces. The distance moved by the glass after one hour was measured, with the position of the edge of the glass when first placed in the oven as the starting point. The results are shown in Table 4.

### Comparative Example 7

Fabrication and evaluation of a laminate were performed as for example 14, except that PSA sheet 8 was substituted for PSA sheet 5. The results are shown in Table 4.

TABLE 4
Table 4: Holding power of pressure sensitive adhesive sheet

| Sample | | Compound | Result after |
|---|---|---|---|
| Number | PSA | (proportion) | 1 hour |
| Example 14 | PSA Sheet - 5 | Polymer 3/DCP-A/TPO = | No |
| | | 95/5/0.5 | movement |
| Comparative | PSA Sheet - 8 | Polymer 2/DCP-A/TPO = | 1 mm |
| Example 7 | | 95/5/0.5 | movement |

As can be seen from the results in Table 4, PSA sheet 5 displayed greater holding power than PSA sheet 8. The polymer in the PSA sheet 5 is capable of copolymerization with the plasticizer DCP-A because it has a radiation reactive site, but the polymer in the PSA sheet 8 is not capable of copolymerization with DCP-A because it does not have such a site. PSA sheet 5 is capable of yielding relatively high holding power because it allows for powerful crosslinking including the plasticizer.

1. A radiation curable pressure sensitive adhesive sheet comprising a (meth)acrylic copolymer having a radiation reactive site and a plasticizer capable of bonding with the (meth)acrylic copolymer upon being irradiated.

2. The radiation curable pressure sensitive adhesive sheet according to claim 1, wherein the radiation reactive site has an ethylenically-unsaturated structure.

3. The radiation curable pressure sensitive adhesive sheet according to claim 1, wherein the radiation reactive site has a benzophenone structure.

4. The radiation curable pressure sensitive adhesive sheet according to claim 1, wherein the plasticizer comprises a polyfunctional (meth)acrylate.

5. The radiation curable pressure sensitive adhesive sheet according to claim 1, wherein the plasticizer comprises a cycloaliphatic moiety.

6. The radiation curable pressure sensitive adhesive sheet according to claim 1, wherein a storage modulus of the pressure sensitive adhesive sheet before irradiation is 1.0×10⁴ Pa or more and 1.0×10⁶ Pa or less at 30° C. and 1 Hz, and 5.0×10⁴ Pa or less at 80° C. and 1 Hz; and
a storage modulus of the pressure sensitive adhesive sheet after irradiation is 1.0×10³ Pa or more at 130° C. and 1 Hz.

7. The radiation curable pressure sensitive adhesive sheet according to claim 6, wherein the storage modulus of the pressure sensitive adhesive sheet after irradiation is 1.0×10⁴ Pa or more at 130° C. and 1 Hz.

8. A laminate comprising a substrate and a radiation curable pressure sensitive adhesive sheet as described in claim 1.

9. A laminate comprising a first substrate, a second substrate, and a radiation curable pressure sensitive adhesive sheet as described in claim 1 disposed between the first substrate and the second substrate, wherein at least one surface of the first substrate is in contact with the radiation curable pressure sensitive adhesive sheet.

10. The laminate according to claim 9, wherein the first substrate is a surface protecting layer, and the second substrate is an image display module or a touch panel.

11. A method of manufacturing a laminate, the laminate comprising a first substrate, a second substrate, and a radiation curable pressure sensitive adhesive sheet as described in claim 1 disposed between the first substrate and the second substrate,
wherein at least one of the first substrate and the second substrate has a three-dimensional surface topography extending over at least a portion of a major surface thereof; the method comprising the steps of:
disposing the radiation curable pressure sensitive adhesive sheet adjacent to at least one surface side of the first substrate;
disposing the second substrate adjacent to the radiation curable pressure sensitive adhesive sheet;
heating and/or pressurizing the radiation curable pressure sensitive adhesive sheet to conform to the three-dimensional surface topography; and
irradiating a radiation on the radiation curable pressure sensitive adhesive sheet.

12. A method of manufacturing a laminate, the laminate comprising a first substrate, a second substrate, and a radiation curable pressure sensitive adhesive sheet as described in claim 1, wherein at least one of the first substrate and the second substrate is distortion sensitive; the method comprising the steps of:
disposing the radiation curable pressure sensitive adhesive sheet adjacent to at least one surface side of the first substrate;
disposing the second substrate adjacent to the radiation curable pressure sensitive adhesive sheet;
heating and/or pressurizing the radiation curable pressure sensitive adhesive sheet; and
irradiating a radiation on the radiation curable pressure sensitive adhesive sheet.
